(19) United States
(12) Patent Application Publication
(10) Pub. No.: US 2019/0320407 A1
(43) Pub. Date: Oct. 17, 2019

(54) RANGE-BASED PROVISION OF NETWORK SERVICES

(71) Applicant: QUALCOMM Incorporated, San Diego, CA (US)

(72) Inventors: Govind GOYAL, Bangalore (IN); Prabhat RAI, Bangalore (IN)

(21) Appl. No.: 15/985,446

(22) Filed: May 21, 2018

(30) Foreign Application Priority Data
Apr. 12, 2018 (IN) 201841014032

(51) Int. Cl. H04W 64/00; H04L 12/26; H04L 29/08; H04W 4/02; H04W 8/00; H04W 56/00; H04W 72/04; H04W 24/10; H04W 76/14

(52) U.S. Cl. CPC H04W 64/003; H04L 43/0864; H04L 67/1061; H04W 4/023; H04W 76/14; H04W 56/001; H04W 72/0446; H04W 24/10; H04W 8/005

(57) ABSTRACT

This disclosure provides systems, devices, apparatus and methods, including computer programs, for triggering the provision of network services based on a ranging operation. Some implementations specifically relate to triggering the establishment of a second wireless link with a peer device responsive to the results of a ranging operation performed via a first wireless link. Some implementations are even more specifically directed to triggering SoftAP functionality to provide access point services to a peer device via a BSS link responsive to determining that the peer device is within a proximity threshold based on an FTM-based ranging operation performed via a P2P link. In some such implementations, the P2P link, which may be a NAN link, is used for discovery, synchronization, acquiring ranging information and monitoring for proximity while the BSS link is used to exchange data such as content retrieved from external networks or information to be transmitted to external networks.

### PRIORITY INFORMATION

This application claims the benefit of priority, under 35 U.S.C. § 119, to Indian patent application no. 201841014032 filed 12 Apr. 2018, the disclosure of which is hereby incorporated by reference herein in its entirety.

### TECHNICAL FIELD

This disclosure relates generally to wireless communications, and more specifically, to triggering the provision of one or more wireless network services based on the results of a ranging operation.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Some STAs also can establish peer-to-peer (P2P), ad hoc or mesh networks enabling the STAs to communicate directly with each other (without the use of an intermediary AP). Some STAs may be configured to provide network services to other peer STAs in their vicinities. For example, a STA may include software-enabled access point (SoftAP) functionality enabling the STA to operate as a Wi-Fi hotspot to provide client STAs with access to external networks via an associated WLAN or WWAN backhaul. While operating as a Wi-Fi hotspot, the STA periodically powers on a transmit (Tx) chain to broadcast Wi-Fi beacons to enable the client STAs to discover and associate with the STA operating as the Wi-Fi hotspot. Additionally, while operating as a Wi-Fi hotspot, a receive (Rx) chain of the STA must generally remain on to receive any Wi-Fi frames sent by client STAs. Because powering on the Tx and Rx chains consumes power, and because power conservation is especially important for STAs that are mobile devices (for example, cellular- and Wi-Fi-enabled smartphones), a user of such a STA must manually enable/start the SoftAP functionality to begin Wi-Fi hotspot operation, for example, by toggling on or otherwise changing one or more network settings via an on-device graphical user interface (GUI). Similarly, the user must manually disable/stop the SoftAP functionality to cease Wi-Fi hotspot operation when it is no longer desired.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a first wireless communication device. In some implementations, the method includes receiving a first message from a second wireless communication device via a first wireless link, the first message including a request for a network service. The method also includes performing a first ranging operation with the second wireless communication device via the first wireless link. The method additionally includes providing the network service to the second wireless communication device responsive to determining, based on the first ranging operation, that the second wireless communication device is within a proximity threshold of the first wireless communication device.

Another innovative aspect of the subject matter described in this disclosure can be implemented in a wireless communication device. In some implementations, the wireless communication device includes at least one processor, and at least one memory communicatively coupled with the at least one processor and storing processor-readable code that, when executed by the at least one processor, causes the wireless communication device to perform various operations. The code is executable to receive a first message from a second wireless communication device via a first wireless link, the first message including a request for a network service. The code also is executable to perform a first ranging operation with the second wireless communication device via the first wireless link. The code is additionally executable to provide the network service to the second wireless communication device responsive to determining, based on the first ranging operation, that the second wireless communication device is within a proximity threshold of the first wireless communication device.

Another innovative aspect of the subject matter described in this disclosure can be implemented in a tangible computer-readable storage medium comprising non-transitory processor-executable code operable to receive a first message from a second wireless communication device via a first wireless link, the first message including a request for a network service. The code also is operable to perform a first ranging operation with the second wireless communication device via the first wireless link. The code is additionally operable to provide the network service to the second wireless communication device responsive to determining, based on the first ranging operation, that the second wireless communication device is within a proximity threshold.

In some implementations of the methods, wireless communication devices and computer-readable storage media, providing the network service includes configuring a Wi-Fi module of the first wireless communication device to operate as an access point to provide the second wireless communication device with access to one or more networks. In some such implementations, providing the network service further includes establishing a second wireless link with the second wireless communication device in which the second wireless communication device is a client of the first wireless communication device, and transmitting one or more wireless packets to the second wireless communication device via the second wireless link.

In some implementations of the methods, wireless communication devices and computer-readable storage media, providing the network service further includes, after the establishment of the second wireless link with the second wireless communication device, performing a second ranging operation with the second wireless communication device via the first wireless link, determining, based on the second ranging operation, that the second wireless communication device is outside of the proximity threshold, and terminating the second wireless link responsive to the determination that the second wireless communication device is outside of the proximity threshold. In some such implementations, the first ranging operation is performed in a first discovery window and the second ranging operation is performed during a subsequent discovery window.

In some implementations of the methods, wireless communication devices and computer-readable storage media, the first wireless link is a peer-to-peer wireless link. For example, the first wireless link can be a NAN link in accordance with the Wi-Fi Alliance Neighbor Awareness Networking standard specification, and the first message can be a NAN subscribe message. In some implementations, the methods, wireless communication devices and computer-readable storage media are further configured to transmit a NAN publish message indicating a capability to provide the network service.

In some implementations of the methods, wireless communication devices and computer-readable storage media, performing the ranging operation includes performing a fine timing measurement (FTM) operation with the second wireless communication device via the first wireless link. In some such implementations, determining that the second wireless communication device is within the proximity threshold includes comparing a range indication obtained via the FTM operation to a configurable threshold value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows a block diagram of an example access point (AP) for use in wireless communication.

FIG. 4 shows a block diagram of an example (STA) for use in wireless communication.

FIG. 5 shows a timing diagram illustrating an example process for performing a ranging operation.

FIG. 6 shows a flowchart illustrating an example process for providing a network service according to some implementations.

FIG. 7 shows a flowchart illustrating an example process for providing access point services according to some implementations.

FIG. 8 shows a flowchart illustrating an example process for providing access point services according to some implementations.

FIG. 9 shows a block diagram of an example wireless communication device for use in wireless communication according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to triggering the provision of one or more network services based on the results of a ranging operation. Some implementations more specifically relate to triggering the establishment of a second wireless link with a peer device responsive to the results of a ranging operation performed via a first wireless link with the peer device. Some implementations are even more specifically directed to triggering software-enabled access point (SoftAP) functionality to provide access point services to a peer device via a Basic Service Set (BSS) link responsive to determining that the peer device is within a proximity threshold based on a fine timing measurement (FTM)-based ranging operation performed via a peer-to-peer (P2P) link. In some such implementations, the P2P link, which may be a neighbor awareness network (NAN) link, is used for discovery, synchronization, acquiring ranging information and monitoring for proximity while the BSS link is used to exchange data such as content retrieved from external networks or information to be transmitted to external networks.

Particular implementations of the subject matter described in this disclosure can be implemented to realize one or more of the following potential advantages. In some implementations, the described techniques can be used to intelligently trigger the provision of network services to reduce power consumption and increase battery life. For example, by automatically enabling SoftAP functionality only when a peer device is within a proximity threshold and requesting access point services, the use of the Tx and Rx chains of the transceivers can be limited thereby conserving power. Additionally, because beacons may be transmitted only when SoftAP functionality is enabled, the described techniques also may provide for additional security by not advertising network services during periods of time when no client devices require such services, which could be used by unscrupulous third parties to launch an attack.

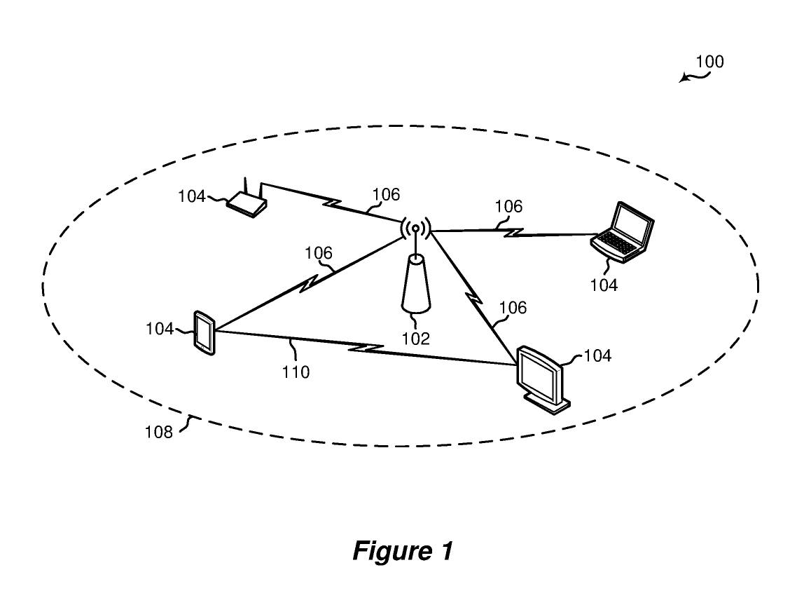

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy LTF (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

The AP 102, as well as some capable STAs 104, may support beamforming. For example, the AP 102 may use multiple antennas or antenna arrays to conduct beamforming operations for directional communications with a STA 104, and vice versa. Beamforming (which may also be referred to as spatial filtering or directional transmission) is a signal processing technique that may be used at a transmitter (for example, AP 102) to shape and/or steer an overall antenna transmission beam in the direction of a target receiver (for example, a STA 104). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 102 may communicate with the STA 104. That is, based on this CSI, the AP 102 may appropriately weight the transmissions from each antenna (for example or antenna port) such that the desired beamforming effects are achieved. In some cases, these weights may be determined before beamforming can be employed. For example, the transmitter (the AP 102) may transmit one or more sounding packets (for example, a null data packet) to the receiver in order to determine CSI.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

Some types of STAs 104 may support automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that can make use of the information, enable automated behavior of machines, or present the information to humans interacting with the program or application. Examples of applications for such devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

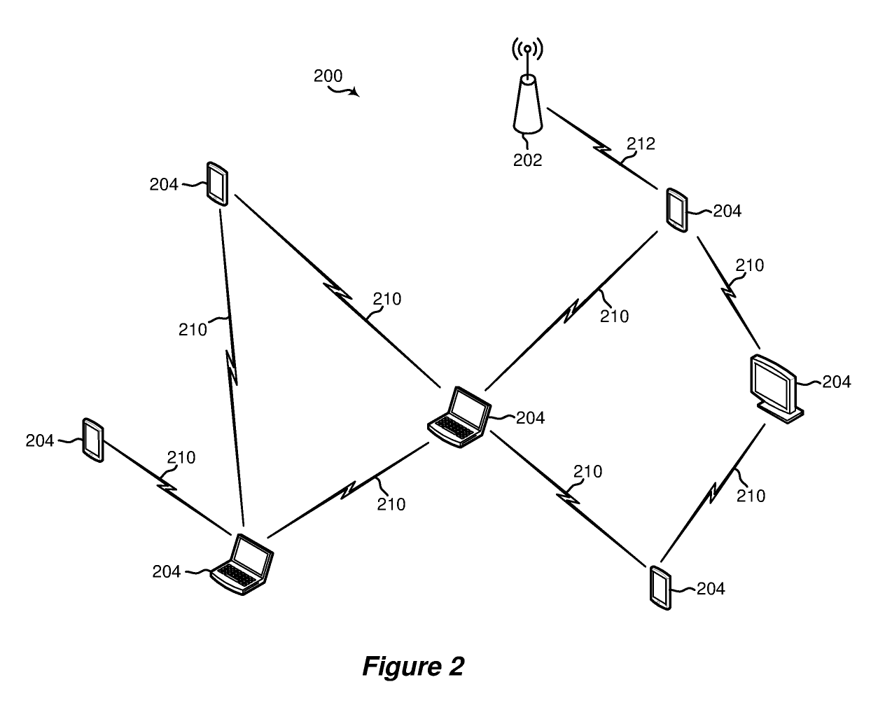

FIG. 2 shows a pictorial diagram of another example wireless communication network 200. According to some aspects, the wireless communication network 200 can be an example of a WLAN. For example, the wireless network 200 can be a network implementing at least one of the IEEE 802.11 family of standards. The wireless network 200 may include multiple STAs 204. As described above, each of the STAs 204 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

The wireless network 200 is an example of a peer-to-peer (P2P), ad hoc or mesh network. STAs 204 can communicate directly with each other via P2P wireless links 210 (without the use of an intermediary AP). In some implementations, the wireless network 200 is an example of a neighbor awareness network (NAN). NANs operate in accordance with the Wi-Fi Alliance (WFA) Neighbor Awareness Networking (also referred to as NAN) standard specification. NAN-compliant STAs 204 (hereinafter also simply “NAN devices 204”) transmit and receive NAN communications (for example, in the form of Wi-Fi packets including frames conforming to an IEEE 802.11 standard such as that defined by the IEEE 802.11-2016 specification or amendments thereof) to and from one another via wireless P2P links 210 (hereinafter also referred to as “NAN links”) using a data packet routing protocol, such as Hybrid Wireless Mesh Protocol (HWMP), for path selection.

A NAN network generally refers to a collection of NAN devices that share a common set of NAN parameters including: the time period between consecutive discovery windows, the time duration of the discovery windows, the NAN beacon interval, and the NAN discovery channel(s). A NAN ID is an identifier signifying a specific set of NAN parameters for use within the NAN network. NAN networks are dynamically self-organized and self-configured. NAN devices 204 in the network automatically establish an ad-hoc network with other NAN devices 204 such that network connectivity can be maintained. Each NAN device 204 is configured to relay data for the NAN network such that various NAN devices 204 may cooperate in the distribution of data within the network. As a result, a message can be transmitted from a source NAN device to a destination NAN device by being propagated along a path, hopping from one NAN device to the next until the destination is reached.

Each NAN device 204 is configured to transmit two types of beacons: NAN discovery beacons and NAN synchronization beacons. When a NAN device 204 is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices 204 passively scan for discovery beacons from other NAN devices. When two NAN devices 204 come within a transmission range of one another, they will discover each other based on such discovery beacons. Respective master preference values determine which of the NAN devices 204 will become the master device. If a NAN cluster is not discovered, a NAN device 204 may start a new NAN cluster. When a NAN device 204 starts a NAN cluster, it assumes the master role and broadcasts a discovery beacon. Additionally, a NAN device may choose to participate in more than one NAN cluster within a NAN network.

The links between the NAN devices 204 in a NAN cluster are associated with discovery windows—the times and channel on which the NAN devices converge. At the beginning of each discovery window, one or more NAN devices 204 may transmit a NAN synchronization beacon, which is a management frame used to synchronize the timing of the NAN devices within the NAN cluster to that of the master device. The NAN devices 204 may then transmit multicast or unicast NAN service discovery frames directly to other NAN devices within the service discovery threshold and in the same NAN cluster during the discovery window. The service discovery frames indicate services supported by the respective NAN devices 204.

In some instances, NAN devices 204 may exchange service discovery frames to ascertain whether both devices support ranging operations. NAN devices 204 may perform such ranging operations (“ranging”) during the discovery windows. The ranging may involve an exchange of fine timing measurement (FTM) frames (such as those defined in IEEE 802.11-REVmc). For example, a first NAN device 204 may transmit unicast FTM requests to multiple peer NAN devices 204. The peer NAN devices 204 may then transmit responses to the first NAN device 204. The first NAN device 204 may then exchange a number of FTM frames with each of the peer NAN devices 204. The first NAN device 204 may then determine a range between itself and each of the peer devices 204 based on the FTM frames and transmit a range indication to each of the peer NAN devices 204. For example, the range indication may include a distance value or an indication as to whether a peer NAN device 204 is within a service discovery threshold (for example, 3 meters(m)) of the first NAN device 204. NAN links between NAN devices within the same NAN cluster may persist over multiple discovery windows as long as the NAN devices remain within the service discovery thresholds of one another and synchronized to the anchor master of the NAN cluster.

Some NAN devices 204 also may be configured for wireless communication with other networks such as with a Wi-Fi WLAN or a wireless (for example, cellular) wide area network (WWAN), which may, in turn, provide access to external networks including the Internet. For example, a NAN device 204 may be configured to associate and communicate, via a Wi-Fi or cellular link 212, with an AP or base station 202 of a WLAN or WWAN network, respectively. In such instances, the NAN device 204 may include software-enabled access point (SoftAP) functionality enabling the STA to operate as a Wi-Fi hotspot to provide other NAN devices 204 with access to the external networks via the associated WLAN or WWAN backhaul. Such a NAN device 204 (referred to as a NAN concurrent device) is capable of operating in both a NAN network as well as another type of wireless network, such as a Wi-Fi BSS. In some such implementations, a NAN device 204 may, in a service discovery frame, advertise an ability to provide such access point services to other NAN devices 204.

There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN may also use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN device link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window followed by a transmission window. All NAN devices participating in a P-NDL operate in a state to receive frames during the paging window. Generally, the participating NAN devices wake up during the paging window to listen on the paging channel to determine whether there is any traffic buffered for the respective devices. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

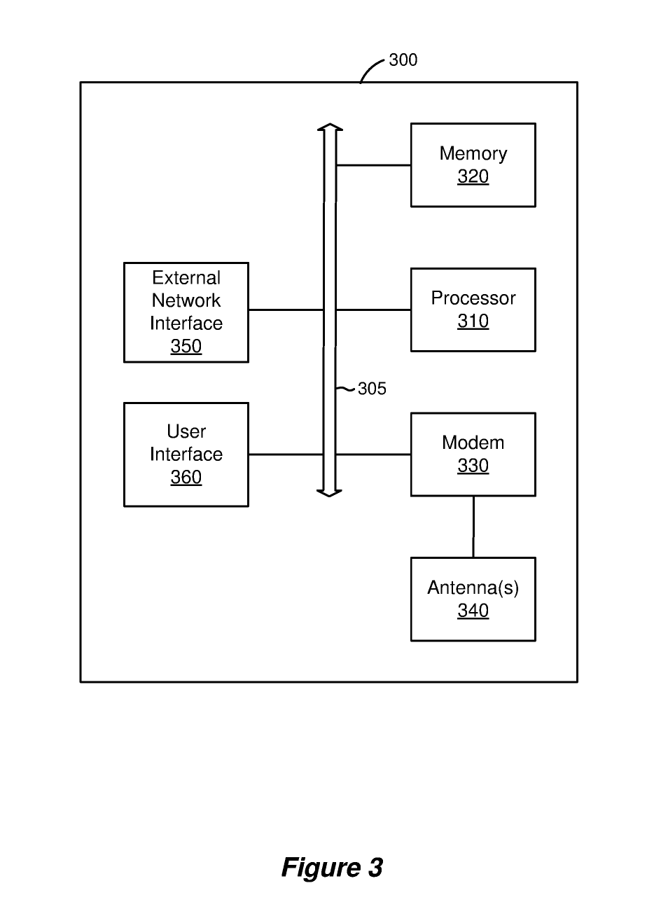

FIG. 3 shows a block diagram of an example access point (AP) 300 for use in wireless communication. For example, the AP 300 may be an example of aspects of the AP 102 described with reference to FIG. 1. The AP 300 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 300 includes at least one processor 310 (collectively “the processor 310”), at least one memory 320 (collectively “the memory 320”), at least one modem 330 (collectively “the modem 330”), at least one antenna 340 (collectively “the antenna 340”), at least one external network interface 350 (collectively “the network interface 350”) and, in some instances, a user interface (UI) 360. Each of the components (or “modules”) described with reference to FIG. 3 can communicate with other ones of the components, directly or indirectly, over at least one bus 305.

The processor 310 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 310 processes information received through the modem 330 and the external network interface 330. The processor 310 also can process information to be sent to the modem 330 for transmission through the antenna 340 and information to be sent to the external network interface 330. The processor 310 can generally be configured to perform various operations related to generating and transmitting a downlink frame and receiving an uplink frame.

The memory 320 can include random access memory (RAM) and read-only memory (ROM). The memory 320 also can store processor- or computer-executable software (SW) code containing instructions that, when executed by the processor 310, cause the processor to perform various functions described herein for wireless communication, including generation and transmission of a downlink frame and reception of an uplink frame.

The modem 330 is generally configured to modulate packets and to provide the modulated packets to the antenna 340 for transmission, as well as to demodulate packets received from the antenna 340 to provide demodulated packets. The modem 330 generally includes or is coupled with at least one radio frequency (RF) transmitter and at least one RF receiver, which may be combined into one or more transceivers, and which are in turn coupled to one or more antennas 340. For example, in some AP implementations, the AP 300 can include multiple transmit antennas (each with a corresponding transmit chain) and multiple receive antennas (each with a corresponding receive chain). The modem 330 can communicate bi-directionally, via the antenna 340, with at least one STA (such as the STA 104 described with reference to FIG. 1).

The modem 330 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

The AP 300 may communicate with a core or backhaul network through the external network interface 350 to gain access to external networks including the Internet. For example, the external network interface 350 may include one or both of a wired (for example, Ethernet) network interface or wireless (for example, LTE, 4G or 5G) network interface.

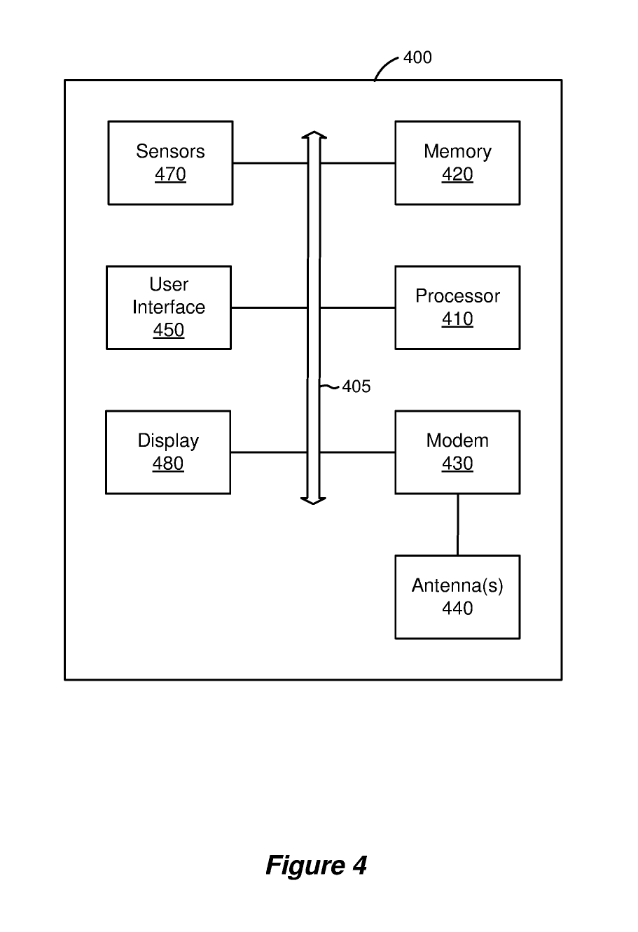

FIG. 4 shows a block diagram of an example wireless station (STA) 400 for use in wireless communication. For example, the STA 400 may be an example of aspects of the STA 104 or the STA 204 described with reference to FIGS. 1 and 2, respectively. The STA 400 is capable of transmitting and receiving wireless communications, as well as of encoding and decoding such communications. The wireless communications may conform to any of a number of different wireless communication protocols. For example, the STA 400 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 400 may be capable of transmitting and receiving Bluetooth packets conforming to a Bluetooth standard, such as defined in IEEE 802.15 or by the Bluetooth SIG. Additionally or alternatively, the STA 400 may be capable of transmitting and receiving wireless packets associated with the Long Term Evolution (LTE), International Mobile Telecommunications-Advanced (IMT-Advanced) 4G or 5G standards.

The STA 400 includes at least one processor 410 (collectively “the processor 410”), at least one memory 420 (collectively “the memory 420”), at least one modem 430 (collectively “the modem 430”) and at least one antenna 440 (collectively “the antenna 440”). In some implementations, the STA 400 additionally includes some or all of the following: a user interface (UI) 450 (such as a touchscreen or keypad), one or more sensors 470 (such as one or more inertial sensors, accelerometers, temperature sensors, pressure sensors, or altitude sensors), and a display 480. Each of the components (or “modules”) described with reference to FIG. 4 can communicate with one another, directly or indirectly, over at least one bus 405.

The processor 410 includes an intelligent hardware device such as, for example, a CPU, a microcontroller, an ASIC or a PLD such as an FPGA, among other possibilities. The processor 410 processes information received through the modem 430 as well as information to be sent to the modem 430 for transmission through the antenna 440. The processor 410 can be configured to perform various operations related to receiving a downlink frame and generating and transmitting an uplink frame.

The memory 420 can include RAM and ROM. The memory 420 also can store processor- or computer-executable SW code containing instructions that, when executed, cause the processor 410 to perform various functions described herein for wireless communication, including reception of a downlink frame and generation and transmission of an uplink frame.

The modem 430 is generally configured to modulate packets and provide the modulated packets to the antenna 440 for transmission, as well as to demodulate packets received from the antenna 440 to provide demodulated packets. The modem 430 generally includes at least one radio frequency (RF) transmitter and at least one RF receiver, which may be combined into one or more transceivers, and which are in turn coupled to one or more antennas 440. For example, in some implementations, the STA 400 can include multiple transmit antennas (each with a corresponding transmit chain) and multiple receive antennas (each with a corresponding receive chain). The modem 430 can communicate bi-directionally, via the antenna 440, with at least one AP (such as the AP 102 or AP 400 described with reference to FIGS. 1 and 4, respectively). As is described above, in some implementations, the modem also can communicate bi-directionally, via the antenna 440, with other STAs directly without the use of an intermediary AP.

The modem 430 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 410 for processing, evaluation or interpretation, for example, by one or more host applications executing on the processor.

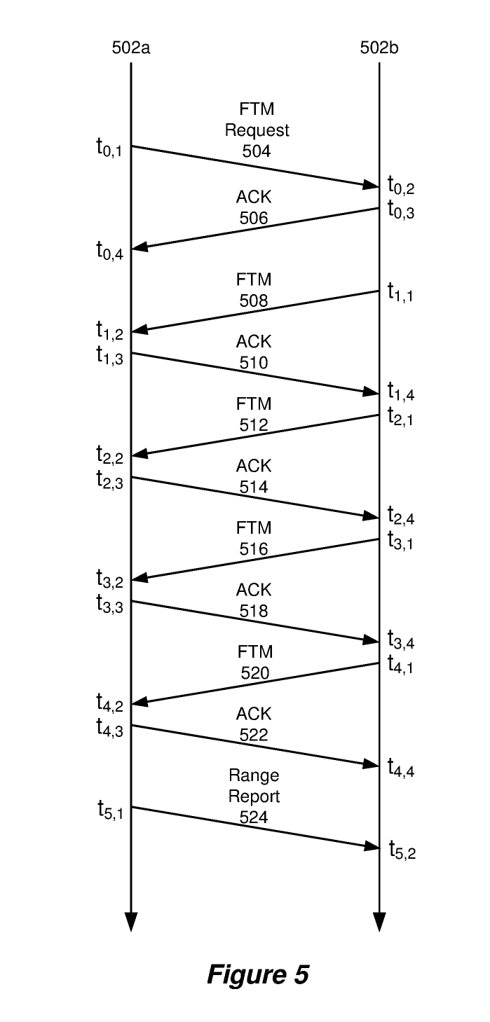

As described above, STAs 400 that are NAN-compliant perform ranging operations during discovery windows. The ranging operation may involve an exchange of fine timing measurement (FTM) frames (such as those defined in the IEEE 802.11mc specification or revisions or updates thereof). FIG. 5 shows a timing diagram illustrating an example process for performing a ranging operation 500. The process for the ranging operation 500 may be conjunctively performed by two wireless devices 502a and 502b, which may each be an example of a STA such as the NAN device 204 described with reference to FIG. 2 or the STA 400 described with reference to FIG. 4.

The ranging operation 500 begins in block 502 with the first wireless device 502a transmitting an initial FTM range request frame 504 at time t_{0,1}. Responsive to successfully receiving the FTM range request frame 504 at time t_{0,2}, the second wireless communication device 502b responds by transmitting a first ACK 506 at time t_{0,3}, which the first wireless device 502a receives at time t_{0,4}. The first wireless device 502a and the second wireless communication device 502b then exchange one or more FTM bursts, which may each include a number of exchanges of FTM action frames (hereinafter simply “FTM frames”) and corresponding ACKs. One or more of the FTM request frame 504 and the FTM action frames (hereinafter simply “FTM frames”) may include FTM parameters specifying various characteristics of the ranging operation 500.

In the example shown in FIG. 5, in a first exchange, beginning at time t_{1,1}, the second wireless communication device 502b transmits a first FTM frame 508. The second wireless communication device 502b records the time t_{1,1} as the time of departure (TOD) of the first FTM frame 508. The first wireless device 502a receives the first FTM frame 508 at time t_{1,2} and transmits a first acknowledgement frame (ACK) 510 to the second wireless communication device 502b at time t_{1,3}. The first wireless device 502a records the time t_{1,2} as the time of arrival (TOA) of the first FTM frame 508, and the time t_{1,3} as the TOD of the first ACK 510. The second wireless communication device 502b receives the first ACK 510 at time t_{1,4} and records the time t_{1,4} as the TOA of the first ACK 510.

Similarly, in a second exchange, beginning at time t_{2,1}, the second wireless communication device 502b transmits a second FTM frame 512. The second FTM frame 512 includes a first field indicating the TOD of the first FTM frame 508 and a second field indicating the TOA of the first ACK 510. The first wireless device 502a receives the second FTM frame 512 at time t_{2,2} and transmits a second ACK 514 to the second wireless communication device 502b at time t_{2,3}. The second wireless communication device 502b receives the second ACK 514 at time t_{2,4}. Similarly, in a third exchange, beginning at time t_{3,1}, the second wireless communication device 502b transmits a third FTM frame 516. The third FTM frame 516 includes a first field indicating the TOD of the second FTM frame 512 and a second field indicating the TOA of the second ACK 514. The first wireless device 502a receives the third FTM frame 516 at time t_{3,2} and transmits a third ACK 518 to the second wireless communication device 502b at time t_{3,3}. The second wireless communication device 502b receives the third ACK 518 at time t_{3,4}. Similarly, in a fourth exchange, beginning at time t_{4,1}, the second wireless communication device 502b transmits a fourth FTM frame 520. The fourth FTM frame 520 includes a first field indicating the TOD of the third FTM frame 516 and a second field indicating the TOA of the third ACK 518. The first wireless device 502a receives the fourth FTM frame 520 at time t_{4,2} and transmits a fourth ACK 522 to the second wireless communication device 502b at time t_{4,3}. The second wireless communication device 502b receives the fourth ACK 522 at time t_{4,4}.

The first wireless device 502a determines a range indication based on the TODs and TOAs described above. For example, in implementations or instances in which an FTM burst includes four exchanges of FTM frames as described above, the first wireless device 502a may be configured to determine a round trip time (RTT) between itself and the second wireless communication device 502b based on Equation 1 below.

RTT=1/3(Σₖ₌₁³t_{4,k}−Σₖ₌₁³t_{1,k})−(Σₖ₌₁³t_{3,k}−Σₖ₌₁³t_{2,k}) (1)

In some implementations, the range indication is the RTT. Additionally or alternatively, in some implementations, the first wireless device 502a may determine an actual approximate distance between itself and the second wireless communication device 502b, for example, by multiplying the RTT by an approximate speed of light in the wireless medium. In such instances, the range indication may additionally or alternatively include the distance value. Additionally or alternatively, the range indication may include an indication as to whether the second wireless communication device 502b is within a proximity (for example, a service discovery threshold) of the first wireless device 502a based on the RTT. In some implementations, the first wireless device 502a may then transmit the range indication to the second wireless communication device 502b, for example, in a range report 524 at time t_{5,1}, which the second wireless communication device receives at time t_{5,2}.

As described above, some STAs may be configured to provide access to external networks to other peer STAs (“client STAs”) in their vicinities that may, for example, at least currently lack such access capabilities. For example, such a STA may include SoftAP functionality enabling the STA to operate as a Wi-Fi hotspot to provide the client STAs with access to the external networks via an associated WLAN or WWAN backhaul. While operating as a Wi-Fi hotspot, the STA periodically powers on a transmit (Tx) chain to broadcast Wi-Fi beacons according to the TBTT to enable the client STAs to discover and associate with the STA operating as the Wi-Fi hotspot. Additionally, while operating as a Wi-Fi hotspot, a receive (Rx) chain of the STA must generally remain on to receive any Wi-Fi frames sent by client STAs. When no other STAs are associated or seeking association with the STA that is serving as the Wi-Fi hotspot, there is no need to transmit such beacons or to maintain the Rx chain(s) in an operational (“on”) mode indefinitely. As such, it is advantageous to maintain Wi-Fi operation only when it is desired to provide network access to other STAs. Power conservation is especially important for STAs that are mobile devices (for example, cellular- and Wi-Fi-enabled smartphones) because they are typically powered via on-device batteries. As such, a user of such a STA must manually enable/start the SoftAP functionality to begin Wi-Fi hotspot operation, for example, by toggling on or otherwise changing one or more network settings via an on-device graphical user interface (GUI). Similarly, the user must manually disable/stop the SoftAP functionality to cease Wi-Fi hotspot operation when it is no longer desired.

Various implementations relate generally to triggering the provision of one or more network services based on the results of a ranging operation. Some implementations more specifically relate to triggering the establishment of a second wireless link with a peer device responsive to the results of a ranging operation performed via a first wireless link with the peer device. Some implementations are even more specifically directed to triggering software-enabled access point (SoftAP) functionality to provide access point services to a peer device via a Basic Service Set (BSS) link responsive to determining that the peer device is within a proximity threshold based on a fine timing measurement (FTM)-based ranging operation performed via a peer-to-peer (P2P) link. In some such implementations, the P2P link, which may be a neighbor awareness network (NAN) link, is used for discovery, synchronization, acquiring ranging information and monitoring for proximity while the BSS link is used to exchange data such as content retrieved from external networks or information to be transmitted to external networks.

Particular implementations of the subject matter described in this disclosure can be implemented to realize one or more of the following potential advantages. In some implementations, the described techniques can be used to intelligently trigger the provision of network services to reduce power consumption and increase battery life. For example, by automatically enabling SoftAP functionality only when a peer device is within a proximity threshold and requesting access point services, the use of the Tx and Rx chains of the transceivers can be limited thereby conserving power. Additionally, because beacons may be transmitted only when SoftAP functionality is enabled, the described techniques also may provide for additional security by not advertising network services during periods of time when no client devices require such services, which could be used by unscrupulous third parties to launch an attack.

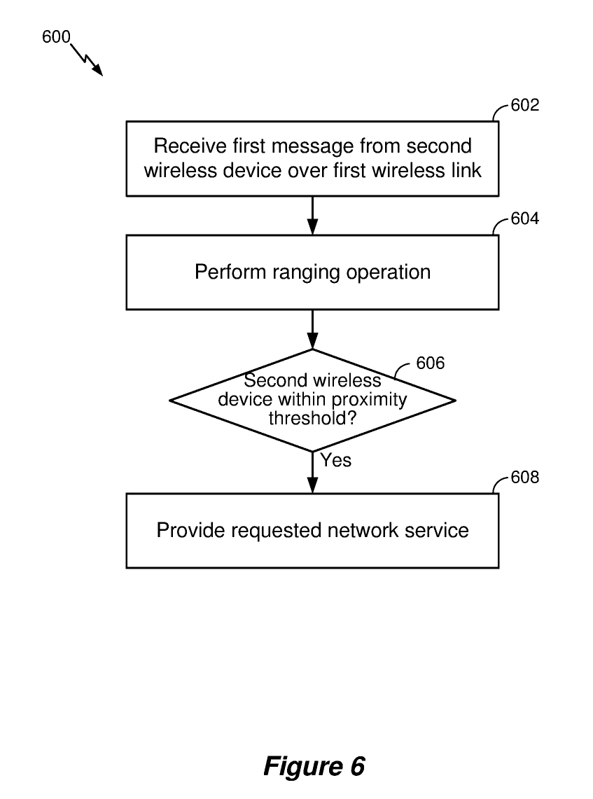

FIG. 6 shows a flowchart illustrating an example process 600 for providing a network service according to some implementations. In some implementations, the process 600 may be performed by a first wireless communication device such as one of the STAs 104, 204 and 400 described above with reference to FIGS. 1, 2 and 4, respectively. In some implementations, the process 600 begins in block 602 with receiving a first message from a second wireless communication device via a first wireless link. For example, the first wireless link can be a P2P link and, in some such implementations, a NAN link. Alternatively, the first wireless link can be another type of P2P link such as a WFA Wi-Fi Direct link. The first message includes a request for a network service that, in this example, the first wireless communication device is able to provide. In block 604, the process 600 proceeds with performing a ranging operation with the second wireless communication device via the first wireless link. In block 606, the process 600 proceeds with determining, based on the ranging operation, whether the second wireless communication device is within a proximity threshold of the first wireless communication device. If it is determined in block 606 that the second wireless communication device is within the proximity threshold, the process 600 proceeds in block 608 with providing the network service to the second wireless communication device.

In some implementations, performing the ranging operation in block 604 includes performing a fine timing measurement (FTM) ranging operation with the second wireless communication device via the first wireless link. For example, the ranging operation performed in block 604 can include an FTM ranging operation such as the ranging operation 500 described with reference to FIG. 5. In some implementations, determining whether the second wireless communication device is within the proximity threshold includes comparing a range indication obtained via the FTM ranging operation to a proximity threshold value. The proximity threshold value may be a configurable parameter (for example, 3 m). In some NAN implementations, the proximity threshold can be the same as the service discovery threshold.

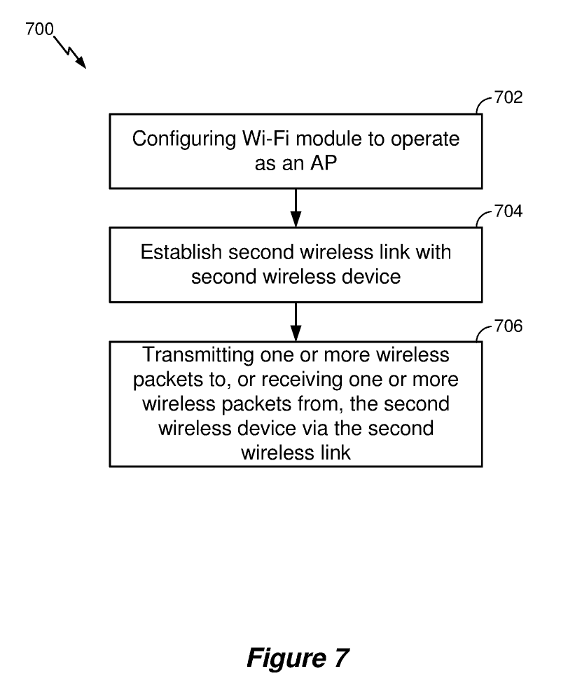

In some implementations, the requested network service includes access point services. In such instances, providing the network service in block 608 includes providing the second wireless communication device with access to one or more external networks. In such instances, the first wireless communication device includes SoftAP functionality enabling it to operate as a Wi-Fi hotspot to provide the second wireless communication device with access to the external networks via an associated WLAN or WWAN backhaul. FIG. 7 shows a flowchart illustrating an example process 700 for providing access point services according to some implementations. For example, the performance of the process 700 may implement the performance of block 608 of the process 600.

In some implementations, the process 700 begins in block 702 with initiating SoftAP functionality. Initiating SoftAP functionality in block 702 may include executing a SoftAP application or algorithm and configuring a Wi-Fi module of the first wireless communication device to operate as an access point to provide access to one or more external networks. Configuring the Wi-Fi module of the first wireless communication device to operate as an access point in block 702 may include initializing, selecting or otherwise configuring BSS parameters such as, for example, an SSID, a frequency band, a primary channel, and security protocol information, among other possibilities.

The process 700 proceeds in block 704 with establishing a second wireless link with the second wireless communication device. For example, the second wireless link can be an IEEE 802.11 infrastructure BSS link in which the first wireless communication device manages and serves as the redistribution point for the BSS, and in which the second wireless communication device is a client station of the BSS (hereinafter such a link is referred to as a “BSS link”). Establishing the BSS link generally includes performing discovery, authentication and association operations with the second wireless communication device. In some implementations, establishing the second wireless link in block 704 includes transmitting a beacon including an SSID of the BSS on a first frequency channel, receiving an association request from the second wireless communication device, and transmitting an association response to the second wireless communication device. Alternatively, establishing the second wireless link in block 704 can include receiving a probe request from the second wireless communication device on a first frequency channel, transmitting a probe response to the second wireless communication device, receiving an association request from the second wireless communication device, and transmitting an association response to the second wireless communication device.

The process 700 may then proceed in block 706 with transmitting one or more wireless packets to, or receiving one or more wireless packets from, the second wireless communication device via the second wireless link. That is, in such implementations, data received from the second wireless communication device and destined for external networks, as well as data received from external networks and destined for the second wireless communication device, is transmitted over the second wireless link as opposed to the first wireless link. In some such implementations, the first wireless link is used for discovery, synchronization, acquiring ranging information and monitoring for proximity while the second wireless link is used to exchange data such as content retrieved from external networks or information to be transmitted to external networks.

Referring back to FIG. 6, in some implementations, after provision of the network service is initiated in block 608, the process 600 may proceed with performing another ranging operation via the first wireless link. If it is determined, based on the additional ranging operation, that the second wireless communication device remains within the proximity threshold, then the network service may continue to be provided subject to additional ranging operations performed at regular intervals, such as during each periodic discovery window. If, on the other hand, it is determined that the second wireless communication device is outside of the proximity threshold, then the process 600 may proceed with ceasing the provision of the network service to the second wireless communication device.

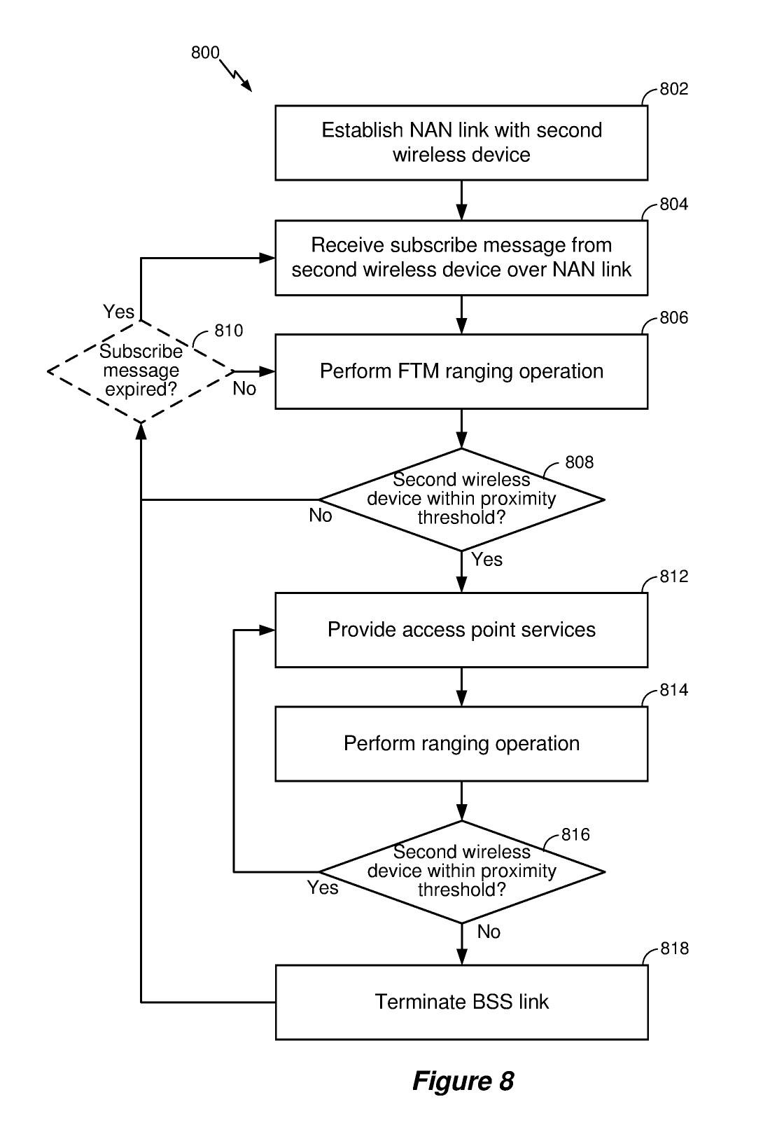

FIG. 8 shows a flowchart illustrating an example process 800 for providing access point services according to some implementations. In some implementations, the process 800 may be performed by a first wireless communication device such as the STAs 104, 204 and 400 described above with reference to FIGS. 1, 2 and 4, respectively. In some implementations, the process 800 begins in block 802 with establishing a NAN link with a second wireless communication device such as another STA. For example, establishing the NAN link in block 802 may generally include receiving a discovery beacon to join a NAN cluster that includes the second wireless communication device, receiving a synchronization beacon and synchronizing with the NAN cluster, and exchanging initial service discovery frames with the second wireless communication device to ascertain whether it supports ranging operations (for example, FTM-based ranging operations).

The process 800 may then proceed in block 804 with receiving a NAN subscribe message from the second wireless communication device via the NAN link. The subscribe message includes a request for access point services to provide the second wireless communication device with access to one or more external networks. In such instances, the first wireless communication device includes SoftAP functionality enabling it to operate as a Wi-Fi hotspot to provide the second wireless communication device with access to the external networks via an associated WLAN or WWAN backhaul. In some implementations, the subscribe message is received responsive to a publish message transmitted by the first wireless communication device advertising the access point services. In some instances, the first wireless communication device may transmit such a publish message advertising access point services in a beginning portion of each periodic discovery window. In some other instances, the subscribe message may be unsolicited, and in such instances, the process 800 may additionally include transmitting a publish message confirming the ability to provide the requested access point services. Whether solicited or unsolicited, the publish message may include a range parameter indicating a proximity threshold representing the maximum distance at which a subscribing NAN device can avail itself of the access point services of the first wireless communication device.

In block 806, the process 800 proceeds with performing an FTM-based ranging operation with the second wireless communication device via the NAN link. For example, the ranging operation performed in block 806 can include an FTM ranging operation such as the ranging operation 500 described with reference to FIG. 5. The process 800 proceeds in block 808 with determining, based on the ranging operation, whether the second wireless communication device is within a proximity threshold of the first wireless communication device. In some implementations, determining whether the second wireless communication device is within the proximity threshold includes comparing a range indication obtained via the FTM ranging operation to a proximity threshold value, which may be a configurable parameter (for example, 3 m). In some implementations, the proximity threshold can be the same as the service discovery threshold.

If it is determined in block 808 that the second wireless communication device is outside of the proximity threshold, the process 800 may optionally proceed in block 810 with determining whether the subscribe message has expired. If the subscribe message has not expired, the process 800 may return to block 806 for the performance of a next FTM ranging operation at a next discovery window. If the subscribe message has expired, the process 800 may return to block 804, at which time, the first wireless communication device may actively publish its access point services and/or wait for other subscribe requests matching its access point services.

If it is determined in block 808 that the second wireless communication device is within the proximity threshold, the process 800 proceeds in block 812 with providing access point services to the second wireless communication device. In some implementations, providing access point services in block 812 includes initiating SoftAP functionality (if not already initiated, for example, as a result of providing access point services to one or more other subscribing NAN devices) and establishing a BSS link with the second wireless communication device. For example, initiating SoftAP functionality may include executing a SoftAP application or algorithm and configuring a Wi-Fi module of the first wireless communication device to operate as an access point to provide access to one or more external networks. Establishing the BSS link generally includes performing discovery, authentication and association operations with the second wireless communication device. The first and the second wireless communication devices may then exchange wireless packets over the BSS link. That is, in such implementations, data received from the second wireless communication device and destined for external networks, as well as data received from external networks and destined for the second wireless communication device, is transmitted over the BSS link as opposed to the NAN link. In some such implementations, the NAN link is used for discovery, synchronization, acquiring ranging information and monitoring for proximity while the BSS link is used to exchange data such as content retrieved from external networks or information to be transmitted to external networks.

After the establishment of the BSS link, the process 800 may proceed in block 814 with performing another ranging operation via the NAN link. For example, the ranging operation may be performed in the next discovery window. In block 816, the process 800 proceeds with determining, based on the additional ranging operation, whether the second wireless communication device remains within the proximity threshold of the first wireless communication device. If it is determined in block 816 that the second wireless communication device remains within the proximity threshold, then the first wireless communication device may continue to provide the access point services subject to additional ranging operations in repetitions of block 814 performed at regular intervals, such as during each periodic discovery window.

If it is determined in block 816 that the second wireless communication device is now outside of the proximity threshold, the process 800 proceeds in block 818 with terminating the BSS link. In some such instances, the first wireless communication device may transmit a plurality of beacons via the second wireless link after the determination that the second wireless communication device is outside of the proximity threshold and before the termination of the second wireless link. In some implementations, terminating the BSS link in block 818 may include ceasing to transmit beacons advertising the BSS and ceasing to transmit or process frames to or from the second wireless communication device where such frames are based on the associated SSID. In some instances, terminating the BSS link in block 818 includes turning off or otherwise disabling the SoftAP functionality, for example, be ceasing to execute a SoftAP application or algorithm. However, in instances in which the first wireless communication device may be serving as an access point and providing access point services to one or more other wireless communication devices other than the second wireless communication device, the first wireless communication device may continue to execute the SoftAP application and support the other associated BSS links.

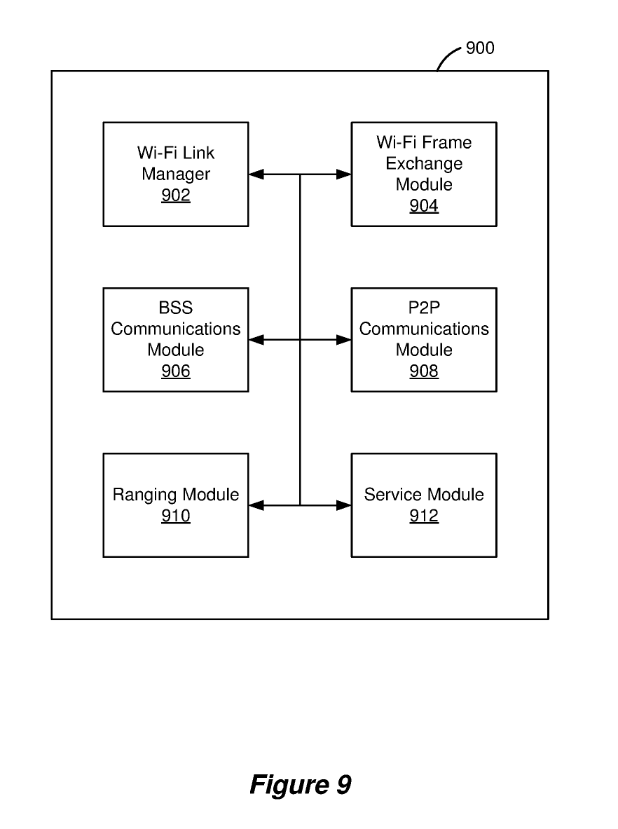

FIG. 9 shows a block diagram of an example wireless communication device 900 for use in wireless communication according to some implementations. In some implementations, the wireless communication device 900 can be an example of the STAs 104, 204 and 400 described above with reference to FIGS. 1, 2 and 4, respectively. In some implementations, the wireless communication device 900 is configured to perform one or more of the processes 600, 700 and 800 described above with reference to FIGS. 6, 7 and 8, respectively. The wireless communication device 900 includes a Wi-Fi link manager 902, a Wi-Fi frame exchange module 904, a Wi-Fi BSS communications module 906, a P2P communications module 908, a ranging module 910, and one or more service modules 912 (collectively referred to herein as “the service module 912”). Portions of one or more of the modules 902, 904, 906, 908, 910 and 912 may be implemented at least in part in hardware or firmware. For example, the Wi-Fi frame exchange module 904 may be implemented at least in part by one or more modems (for example, a Wi-Fi (IEEE 802.11) modem). In some implementations, at least some of the modules 902, 904, 906, 908, 910 and 912 are implemented at least in part as software stored in a memory (such as the memory 420). For example, portions of one or more of the modules 902, 904, 906, 908, 910 and 912 can be implemented as non-transitory instructions (or “code”) executable by at least one processor (such as the processor 410) to perform the functions or operations of the respective module.

The Wi-Fi link manager 902 is configured to manage the creation, maintenance and termination of one or more Wi-Fi links in accordance with the IEEE 802.11 family of standards (such as that defined by the IEEE 802.11-2016 specification or amendments thereof). For example, the Wi-Fi link manager 902 is configured to perform passive or active scanning operations (“scans”) on one or more frequency bands (for example, the 2.4 GHz, 5 GHz, 6 GHz or 60 GHz bands), for example, by listening for beacons (passive scanning) or by generating probe requests and receiving probe responses via a transceiver (active scanning). The Wi-Fi link manager 902 is configured to establish Wi-Fi links with various other devices such as APs and STAs including other wireless communication devices 900.

For example, the Wi-Fi link manager 902, in conjunction with the BSS communications module 906, is configured to perform authentication and association operations to establish a BSS link with a selected AP as a client of the AP. In some implementations, the wireless communication device 900 further includes SoftAP functionality. In such implementations, the Wi-Fi link manager 902 is further configured to perform authentication and association operations to establish BSS links with various client devices to provide access point services as a Wi-Fi hotspot to the client devices. In some implementations, the Wi-Fi link manager 902 is further configured to establish P2P links with various other wireless communication devices such as a number of peer wireless communication devices 900. For example, the Wi-Fi link manager 902, in conjunction with the P2P communications module 908, is configured to perform discovery, authentication, and synchronization operations to join a P2P network group, such as a NAN cluster, and establish P2P links, such as NAN links, with the peer devices.

The Wi-Fi link manager 902 is further configured to monitor a status of each operational Wi-Fi link (including BSS and P2P links), for example, by monitoring the links for beacons or particular types of packets. The Wi-Fi link manager 902 is further configured to disable Wi-Fi links, including BSS and P2P links, responsive to various criteria including signal quality metrics or user input. For example, in some implementations, the Wi-Fi link manager 902 is configured to terminate a BSS link with a second wireless communication device that is a client of the wireless communication device 900 responsive to a notification or instruction from the P2P communications module 908 indicating that the second wireless communication device is no longer within a proximity threshold of the wireless communication device 900.

The Wi-Fi frame exchange module 904 is configured to generate, receive and perform the initial processing of frames implemented via at least one of the IEEE 802.11 family of standards (such as that defined by the IEEE 802.11-2016 specification or amendments thereof). For example, the Wi-Fi frame exchange module 904 is configured to work in conjunction with the BSS communications module 906 and the P2P communications module 908 to generate, receive and process Wi-Fi frames such as management frames (for example, beacon frames, probe request/response frames, and association request/response frames), control frames (for example, Request to Send (RTS) frames, Clear to Send (CTS) frames, and acknowledgement (ACK) frames), data frames, and trigger frames to be transmitted to, or received from, an AP or a STA via a modem. For example, the Wi-Fi frame exchange module 904 may, in conjunction with the BSS communications module 906, relay external network communications received from an AP to one or more client devices. Similarly, the Wi-Fi frame exchange module 904 may, in conjunction with the BSS communications module 906, relay network communications received from one or more client devices to an AP for transmission to one or more external networks.

The Wi-Fi frame exchange module 904 also may, in conjunction with the P2P communications module 906, generate, receive and process communications such as NAN communications including discovery beacons, synchronization beacons, publish and subscribe messages, paging messages and data frames. In some implementations, the Wi-Fi frame exchange module 904 is configured to receive, via a first P2P link, a message from a second wireless communication device that includes a request to subscribe to a network service. The Wi-Fi frame exchange module 904 may then pass the request to the P2P communications module 908. For example, the message can be or include a NAN subscribe message and the requested network service may include access point services to provide the second wireless communication device with access to one or more networks. In some implementations, the Wi-Fi frame exchange module 904 is configured to generate and transmit a publish message at the direction of the P2P communications module 908 that advertises the network service. In some such implementations, the wireless communication device 900 may transmit such a publish message advertising the network service in a beginning portion of each periodic discovery window. In some instances, the subscribe message is received responsive to such a publish message. In some other instances, the subscribe message may be unsolicited. In such instances, the Wi-Fi frame exchange module 904 may, at the direction of the P2P communications module 908, generate and transmit a publish message confirming the ability to provide the requested network service.

The BSS communications module 906 is configured to manage Wi-Fi communications associated with a BSS. For example, in a normal mode of operation, the BSS communications module 906 is configured to manage the communication of packets to and from APs, for example, by providing data to the frame exchange module 904 for the generation of frames to be transmitted to the APs, and by processing data received from the APs via the frame exchange module 904. In some implementations, the BSS communications module 906 is further configured to, in a SoftAP mode of operation, establish a BSS and manage the communications of packets to and from a number of client devices, for example, by providing data to the frame exchange module 904 for the generation of frames to be transmitted to the client devices, and by processing data received from the client devices via the frame exchange module 904.

The P2P communications module 908 is configured to manage the communications of packets to and from a number of peer devices in a P2P network such as, for example, a NAN network, by providing data to the frame exchange module 904 for the generation of frames to be transmitted to the peer devices, and by processing data received from the peer devices via the frame exchange module 904. As described above, in some implementations, the P2P communications module 908 is configured to cause the Wi-Fi frame exchange module 904 to generate and transmit publish messages advertising a capability to provide one or more network services such as access point services. The P2P communications module 908 is further configured to cause the Wi-Fi frame exchange module 904 to relay requests for such network services received in subscribe messages to the P2P communications module 908.

The P2P communications module 908 is further configured to determine whether various criteria are met for providing the requested network service. For example, in some implementations, the P2P communications module 908 is further configured to determine, based on a range indication received from the ranging module 910, whether a second wireless communication device requesting an offered network service is within a proximity threshold of the wireless communication device 900. For example, the P2P communications module 908 can be configured to compare a range indication obtained from the ranging module 910 to a proximity threshold value, which may be a configurable parameter (for example, 3 m).

In instances in which the wireless communication device 900 is not currently providing the network service to the second wireless communication device, if it is determined that the second wireless communication device is within the proximity threshold, the P2P communications module 908 may notify or instruct the service module 912 to provide the indicated network service. In instances in which the wireless communication device 900 is currently providing the network service to the second wireless communication device, if it is determined that the second wireless communication device is within the proximity threshold, the P2P communications module 908 may notify or instruct the service module 912 to continue to provide the indicated network service. In instances in which the wireless communication device 900 is not currently providing the network service to the second wireless communication device, if it is determined that the second wireless communication device is outside of the proximity threshold, the P2P communications module 908 does not notify or instruct the service module 912 to provide the indicated network service. In instances in which the wireless communication device 900 is currently providing the network service to the second wireless communication device, if it is determined that the second wireless communication device is outside of the proximity threshold, the P2P communications module 908 may notify or instruct the service module 912 to discontinue providing the indicated network service.

The ranging module 910 is configured to perform ranging operations via a P2P link, such as a NAN link, established by the Wi-Fi link manager 902. For example, the ranging module 910 can be configured to, during each periodic NAN discovery window, perform an FTM-based ranging operation to determine a proximity of the wireless communication device 900 to other peer wireless communication devices. The result of the ranging operation may be a range indication such as, for example, a distance value or an indication as to whether a peer device is within a configurable proximity threshold of the wireless communication device 900.

The service module 912 is configured to provide one or more services to peer wireless communication devices. In some implementations, the service module 912 includes a SoftAP module enabling the wireless communication device 900 to provide access point services to peer devices to provide such peer devices with access to external networks via an associated WLAN or WWAN backhaul. In such implementations, the service module 912 is configured to provide access point services, in conjunction with the BSS communications module 906, to one or more peer devices responsive to input from the P2P communications module 908. For example, in instances in which the service module 912 is not currently providing the access point services to a second peer wireless communication device, the P2P communications module 908 may notify or instruct the service module 912 to provide the access point services if it determines that the second wireless communication device is within the proximity threshold. In some implementations, to provide the access point services, the service module 912 is configured to initiate the SoftAP module (if not already initiated, for example, as a result of providing access point services to one or more other peer devices) to configure various Wi-Fi settings to establish a BSS link with the second wireless communication device in conjunction with the Wi-Fi link manager 902 and the BSS communications module 906. The BSS communications module 906 may then, in conjunction with the Wi-Fi frame exchange module 904, exchange wireless packets with the second wireless communication device over the BSS link.

In instances in which the service module 912 is currently providing access point services to the second wireless communication device, the P2P communications module 908 may notify or instruct the service module 912 to discontinue providing the access point services to the second wireless communication device if it determines that the second wireless communication device is outside of the proximity threshold. For example, to discontinue providing the access point services, the service module 912 may instruct the Wi-Fi link manager 902 to terminate the BSS link with the second wireless communication device. In some instances, the service module 912 may, in conjunction with instructing the Wi-Fi link manager 902 to terminate the BSS link, turn off or otherwise disable the SoftAP module. However, in instances in which the wireless communication device 900 may be providing access point services to one or more other peer wireless communication devices other than the second wireless communication device, the service module 912 may continue to execute the SoftAP module to support the other associated BSS links.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a first wireless communication device, comprising:
receiving a first message from a second wireless communication device via a first wireless link, the first message including a request for a network service;
performing a first ranging operation with the second wireless communication device via the first wireless link; and
providing the network service to the second wireless communication device responsive to determining, based on the first ranging operation, that the second wireless communication device is within a proximity threshold of the first wireless communication device.

2. The method of claim 1, wherein providing the network service includes configuring a Wi-Fi module of the first wireless communication device to operate as an access point to provide the second wireless communication device with access to one or more networks.

3. The method of claim 2, wherein providing the network service further includes:
establishing a second wireless link with the second wireless communication device in which the second wireless communication device is a client of the first wireless communication device; and
transmitting one or more wireless packets to the second wireless communication device via the second wireless link.

4. The method of claim 3, further including:
after the establishment of the second wireless link with the second wireless communication device, performing a second ranging operation with the second wireless communication device via the first wireless link;
determining, based on the second ranging operation, that the second wireless communication device is outside of the proximity threshold; and
terminating the second wireless link responsive to the determination that the second wireless communication device is outside of the proximity threshold.

5. The method of claim 4, wherein the first ranging operation is performed in a first discovery window and the second ranging operation is performed during a subsequent discovery window.

6. The method of claim 1, wherein the first wireless link is a peer-to-peer wireless link.

7. The method of claim 6, wherein the first wireless link is a NAN link in accordance with the Wi-Fi Alliance Neighbor Awareness Networking standard specification, and wherein the first message is a NAN subscribe message.

8. The method of claim 7, further including transmitting a NAN publish message indicating a capability to provide the network service.

9. The method of claim 1, wherein performing the ranging operation includes performing a fine timing measurement (FTM) operation with the second wireless communication device via the first wireless link.

10. The method of claim 9, wherein determining that the second wireless communication device is within the proximity threshold includes comparing a range indication obtained via the FTM operation to a configurable threshold value.

11. A first wireless communication device comprising:
at least one processor; and
at least one memory communicatively coupled with the at least one processor and storing processor-readable code that, when executed by the at least one processor, causes the wireless communication device to:
receive a first message from a second wireless communication device via a first wireless link, the first message including a request for a network service;
perform a first ranging operation with the second wireless communication device via the first wireless link; and
provide the network service to the second wireless communication device responsive to determining, based on the first ranging operation, that the second wireless communication device is within a proximity threshold of the first wireless communication device.

12. The first wireless communication device of claim 11, wherein to provide the network service the code is executable to configure a Wi-Fi module of the first wireless communication device to operate as an access point to provide the second wireless communication device with access to one or more networks.

13. The first wireless communication device of claim 12, wherein to provide the network service the code is executable to:
establish a second wireless link with the second wireless communication device in which the second wireless communication device is a client of the first wireless communication device; and
transmit one or more wireless packets to the second wireless communication device via the second wireless link.

14. The first wireless communication device of claim 13, wherein the code is further executable to:
after the establishment of the second wireless link with the second wireless communication device, perform a second ranging operation with the second wireless communication device via the first wireless link;
determine, based on the second ranging operation, that the second wireless communication device is outside of the proximity threshold; and
terminate the second wireless link responsive to the determination that the second wireless communication device is outside of the proximity threshold.

15. The first wireless communication device of claim 14, wherein the first ranging operation is performed in a first discovery window and the second ranging operation is performed during a subsequent discovery window.

16. The first wireless communication device of claim 11, wherein the first wireless link is a peer-to-peer wireless link.

17. The first wireless communication device of claim 16, wherein the first wireless link is a NAN link in accordance with the Wi-Fi Alliance Neighbor Awareness Networking standard specification, and wherein the first message is a NAN subscribe message.

18. The first wireless communication device of claim 17, wherein the code is further executable to transmit a NAN publish message indicating a capability to provide the network service.

19. The first wireless communication device of claim 11, wherein to perform the ranging operation the code is executable to perform a fine timing measurement (FTM) operation with the second wireless communication device via the first wireless link.

20. The first wireless communication device of claim 19, wherein to determine that the second wireless communication device is within the proximity threshold, the code is executable to compare a range indication obtained via the FTM operation to a configurable threshold value.

21. A tangible computer-readable storage medium comprising non-transitory processor-executable code operable to:
receive a first message from a second wireless communication device via a first wireless link, the first message including a request for a network service;
perform a first ranging operation with the second wireless communication device via the first wireless link; and
provide the network service to the second wireless communication device responsive to determining, based on the first ranging operation, that the second wireless communication device is within a proximity threshold.

22. The computer-readable storage medium of claim 21, wherein providing the network service includes configuring a Wi-Fi module of the first wireless communication device to operate as an access point to provide the second wireless communication device with access to one or more networks.

23. The computer-readable storage medium of claim 22, wherein providing the network service further includes:
establishing a second wireless link with the second wireless communication device in which the second wireless communication device is a client of the first wireless communication device; and
transmitting one or more wireless packets to the second wireless communication device via the second wireless link.

24. The computer-readable storage medium of claim 23, further including:
after the establishment of the second wireless link with the second wireless communication device, performing a second ranging operation with the second wireless communication device via the first wireless link;
determining, based on the second ranging operation, that the second wireless communication device is outside of the proximity threshold; and
terminating the second wireless link responsive to the determination that the second wireless communication device is outside of the proximity threshold.

25. The computer-readable storage medium of claim 21, wherein performing the ranging operation includes performing a fine timing measurement (FTM) operation with the second wireless communication device via the first wireless link.

26. A first wireless communication device comprising:
means for receiving a first message from a second wireless communication device via a first wireless link, the first message including a request for a network service;
means for performing a first ranging operation with the second wireless communication device via the first wireless link; and
means for providing the network service to the second wireless communication device responsive to determining, based on the first ranging operation, that the second wireless communication device is within a proximity threshold.

27. The first wireless communication device of claim 26, wherein the means for providing the network service include means for configuring a Wi-Fi module of the first wireless communication device to operate as an access point to provide the second wireless communication device with access to one or more networks.

28. The first wireless communication device of claim 27, wherein the means for providing the network service further include:
means for establishing a second wireless link with the second wireless communication device in which the second wireless communication device is a client of the first wireless communication device; and
means for transmitting one or more wireless packets to the second wireless communication device via the second wireless link.

29. The first wireless communication device of claim 28, further including:
means for performing a second ranging operation with the second wireless communication device via the first wireless link after the establishment of the second wireless link with the second wireless communication device;
means for determining, based on the second ranging operation, that the second wireless communication device is outside of the proximity threshold; and
means for terminating the second wireless link responsive to the determination that the second wireless communication device is outside of the proximity threshold.

30. The first wireless communication device of claim 26, wherein the means for performing the ranging operation includes means for performing a fine timing measurement (FTM) operation with the second wireless communication device via the first wireless link.
